(19) United States
(12) Patent Application Publication
(10) Pub. No.: US 2015/0206181 A1
(43) Pub. Date: Jul. 23, 2015

(54) IN-VEHICLE DIGITAL ADVERTISEMENT

(71) Applicant: TOYOTA JIDOSHA KABUSHIKI KAISHA, Toyota-shi (JP)

(72) Inventors: Rahul Parundekar, Sunnyvale, CA (US); Trinell Ball, Stamford, CT (US)

(21) Appl. No.: 14/628,837

(22) Filed: Feb. 23, 2015

Related U.S. Application Data
(63) Continuation-in-part of application No. 14/091,253, filed on Nov. 26, 2013.
(60) Provisional application No. 61/752,354, filed on Jan. 14, 2013.

(51) Int. Cl. G06Q 30/02

(52) U.S. Cl. CPC G06Q 30/0251; G06Q 30/0275

(57) ABSTRACT

A method includes determining a digital advertisement targeted for a user present in a vehicle. The method also includes providing the digital advertisement to be presented to the user in the vehicle. The method also includes receiving data describing an in-vehicle presentation of the digital advertisement. The method also includes determining an advertisement impression compensation paid by an advertiser responsive to the in-vehicle presentation of the digital advertisement. The method also includes receiving data describing a first action acted upon the digital advertisement. The method also includes determining a first action compensation paid by the advertiser based on a first type of the first action. The method also includes determining a total compensation paid by the advertiser. The total compensation includes the advertisement impression compensation and the first action compensation.

### CROSS REFERENCE TO RELATED APPLICATIONS

This application claims priority under 35 U.S.C. §120 to U.S. patent application Ser. No. 14/091,253, filed Nov. 26, 2013 and titled “Managing Interactive In-Vehicle Advertisements,” the entirety of which is herein incorporated by reference.

### BACKGROUND

The specification relates to in-vehicle digital advertisements.

The Internet is changing the way people use their vehicles. For example, historically, people expected to be able to listen to the radio or play compact discs when traveling in their vehicle. However, today people expect their vehicles to include vehicle infotainment systems which may download content to the vehicle from the Internet. For example, a user of the vehicle may stream a podcast or their favorite music from the Internet to their vehicle via their vehicle infotainment system.

### SUMMARY

According to one innovative aspect of the subject matter described in this disclosure, a method includes determining an advertisement targeted for a user present in a vehicle. As used herein, an advertisement refers to an in-vehicle digital advertisement provided, via a network, to the vehicle for presentation to the user present in the vehicle and presented to the user via the hardware of the vehicle. The method also includes providing the advertisement to be presented to the user in the vehicle. The method also includes receiving data describing an in-vehicle presentation of the advertisement. The method also includes determining an advertisement impression compensation paid by an advertiser responsive to the in-vehicle presentation of the advertisement. The method also includes receiving data describing a first action acted upon the advertisement. As used herein, the term “data” refers to digital data. The method also includes determining a first action compensation paid by the advertiser based on a first type of the first action. The method also includes determining a total compensation paid by the advertiser. The total compensation includes the advertisement impression compensation and the first action compensation.

According to another innovative aspect of the subject matter described in this disclosure, a method includes receiving an advertisement targeted for a user present in a vehicle. The method also includes presenting the advertisement to the user in the vehicle. The method also includes determining an occurrence of a button press event. The button press event may be configured to trigger performance of an action. The method also includes determining an occurrence of the action based on the button press event. The method also includes sending data describing the action.

Other aspects include corresponding methods, systems, apparatus, and computer program products for these and other innovative aspects.

These and other implementations may each optionally include one or more of the following operations and features. For instance, the operations include: determining that a performance indicator associated with the first type of the first action is satisfied for a campaign of the advertisement; determining a retroactive bonus compensation paid by the advertiser based on the first type of the first action responsive to the performance indicator being satisfied, the total compensation further including the retroactive bonus compensation; receiving the total compensation from the advertiser; distributing the total compensation in a group of providers that includes an advertisement targeting service provider and an advertisement delivery service provider; conducting an auction process to sell an advertisement time slot for presenting the advertisement in the vehicle; receiving data describing a second action acted upon the advertisement; and determining a second action compensation paid by the advertiser based on a second type of the second action, the total compensation further including the second action compensation.

The operations further include: determining the audio content that conveys the call-to-action message associated with the digital advertisement based on permissible actions available for the digital advertisement; providing the audio content along with the digital advertisement to be presented to the user in the vehicle; receiving data describing an in-vehicle presentation of the audio content that conveys the call-to-action message; and determining the advertisement impression compensation paid by the advertiser responsive to the in-vehicle presentation of the audio content.

For instance, the features include: determining that a percentage between a total number of users that have performed the first action and a total number of users that have been presented with the advertisement satisfies a condition specified in the performance indicator; selecting the advertisement associated with a highest bidding price from the auction process; the first action including one of providing the user with navigation instructions to a location related to the advertisement, calling a phone number related to the advertisement, retrieving review information related to a product mentioned in the advertisement, automatically purchasing a product mentioned in the advertisement from an online store, making a purchase of the product mentioned in the advertisement from a local store, automatically downloading a software program product mentioned in the digital ad from an online store, and digitally storing a digital coupon that is mentioned in the digital ad.

The features further includes: the button press event occurring on a control button of a steering wheel of the vehicle; the button press event occurring on a control button of an in-vehicle infotainment system; receiving a verbal instruction from the user; the occurrence of the action being further determined based on the verbal instruction; incorporating the advertisement into a content stream being played in the vehicle, the advertisement configured to be played at an advertisement time slot; playing the advertisement in the vehicle during the advertisement time slot using one or more of a speaker system and a display device in the vehicle; and the button press event occurring on a rewind hardware button associated with media control in the vehicle.

The features may further include one or more of the following: the digital advertisement and the first action compensation being determined based in part on historical actions performed by at least one of the user and other users; the digital advertisement and the first action compensation being determined based in part on historical actions performed for at least one of the digital advertisement and other digital advertisements; the digital advertisement and the first action compensation being determined based in part on historical actions performed for a current category of digital advertisements that the digital advertisement belongs to; the digital advertisement and the first action compensation being determined based in part on user profile data associated with the user; and the digital advertisement being supplemented with a piece of audio content conveying a call-to-action message.

The disclosure is particularly advantageous in a number of respects. For example, the technologies described herein may provide a mechanism to mitigate costs borne by service providers in a service-providing ecosystem through monetizing advertisements (ads) presented in vehicles. The in-vehicle ads may be monetized using different pricing strategies. For example, different ad compensations may be paid by an advertiser based on different types of actions being triggered responsive to a presentation of an ad. Alternatively or additionally, a performance-based bonus may be paid by the advertiser retroactively if a performance indicator for the ad campaign is satisfied.

Alternatively or additionally, the technologies described herein may include conducting a bidding process through which an inventory of real-time in-vehicle ad slots may be auctioned to advertisers. An advertiser that pays a highest bidding price may win the bid. This bidding approach may result in creating a fair market pricing for the in-vehicle ad. Alternatively or additionally, the technologies may also include using a control button (e.g., a media control button on a steering wheel or a head unit) to trigger an action responsive to a presentation of the in-vehicle ad, thereby triggering an ad compensation from the advertiser. The advantages of the technologies described herein are provided by way of example, and the technologies described herein may have numerous other advantages.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for monetizing advertisement presentations in a mobile client device.

FIG. 2A is a block diagram illustrating an example computing device that includes an example advertisement targeting module.

FIG. 2B is a block diagram illustrating an example computing device that includes an example advertisement delivery module.

FIGS. 3A and 3B are flowcharts of an example method for monetizing advertisement presentations in a mobile client device.

FIGS. 4A-4C are flowcharts of another example method for monetizing advertisement presentations in a mobile client device.

FIG. 5 is a flowchart of an example method for delivering an advertisement to a user.

FIG. 6A is a graphic representation illustrating an example advertisement compensation chart.

FIG. 6B is a graphic representation illustrating another example advertisement compensation chart.

### DETAILED DESCRIPTION

System Overview

This disclosure describes, among other things, an advertisement monetization application (an “ad monetization application”). The ad monetization application beneficially advances the field of providing advertisements to a user present in a vehicle via the hardware of the vehicle (e.g., a display of an in-vehicle infotainment system, speakers, etc.). As used herein, the term “advertisements” refers to an in-vehicle digital advertisement provided, via a network, to the vehicle for presentation to the user present in the vehicle and presented to the user via the hardware of the vehicle. The term “ad” also refers to an in-vehicle digital advertisement provided, via a network, to the vehicle for presentation to the user present in the vehicle and presented to the user via the hardware of the vehicle. The terms “advertisement” and “ad” do not include non-digital ads or ads occurring outside of the context of a vehicle.

Vehicles include in-vehicle infotainment systems. In-vehicle infotainment systems include programs called ‘applications’ running on them. These applications are able to provide infotainment services to the user. These infotainment services include providing the user with in-vehicle content. The in-vehicle content may include listening to music or audio programs in the vehicle, searching for a point-of-interest (e.g. gas station, bank, etc.) with or without network coverage, providing passengers with videos, etc.

In delivering in-vehicle content such as these to the user, there are costs incurred by the service providers. These costs can include costs involved in licensing content, delivery of the content, content revision/update, etc. These costs may also include payments for additional hardware required to enable these services.

The service providers may be a multitude of players who cooperate to provide the infotainment services to the user. In this case, the costs can be distributed between multiple players in the entire ecosystem. Some infotainment devices involved in providing the infotainment services (e.g. the hardware involved in frequency modulated (“FM”) radio player, or the hardware and software head unit) are sold separately. The costs of such infotainment devices may be borne by the user, and so, the user wants such costs minimized.

With the competitive vehicle sales market, and the demand by users for such infotainment services, the manufacturers of infotainment devices are forced to sell their infotainment devices at a price that may forgo profits. All such players in the service-providing ecosystem need ways to mitigate their costs.

Ads may be used to generate revenue and mitigate the costs described above, as well as generate profits. The ad monetization application may beneficially advance the domain of providing in-vehicle digital ads to a vehicle via a network in such a way that the ads are targeted for the particular user present in the vehicle at the time the ad content is presented in the vehicle.

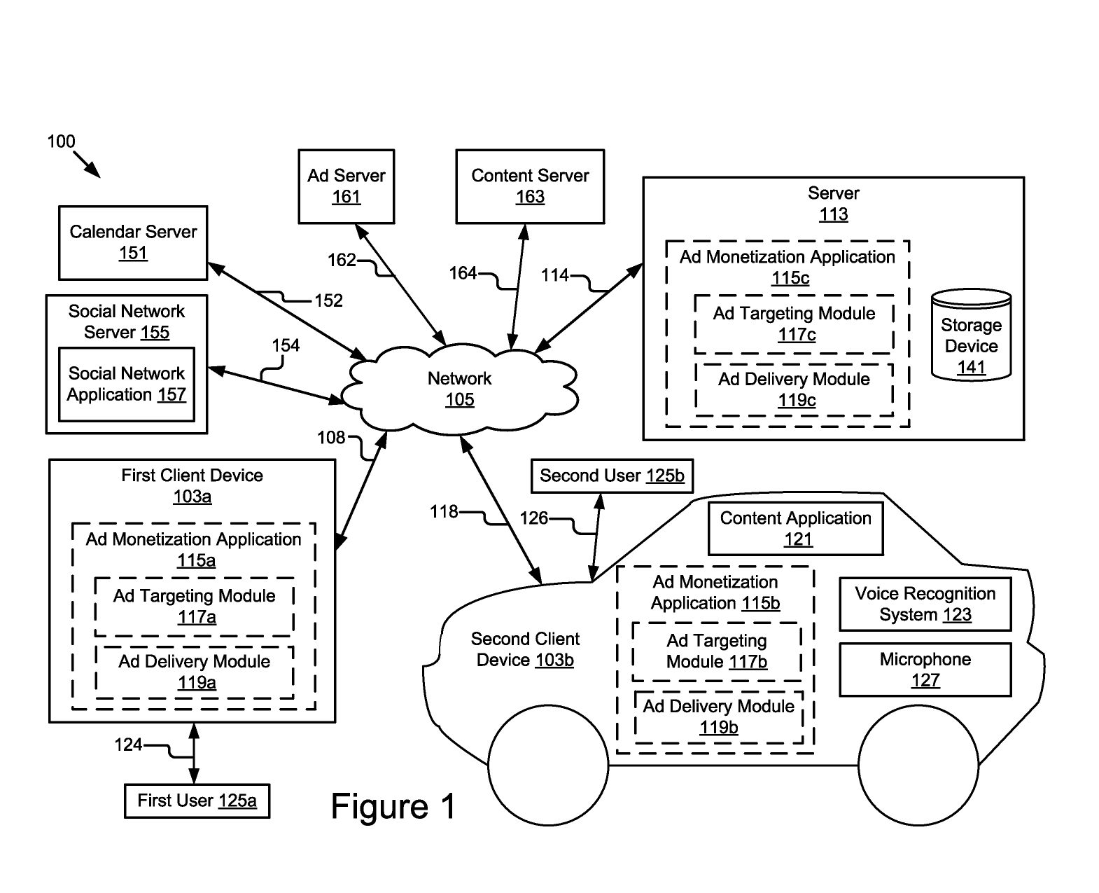

FIG. 1 illustrates a block diagram of some implementations of a system 100 for monetizing advertisement (ad) presentations in a mobile client device. The system 100 may include a calendar server 151, a social network server 155, a first client device 103a, a second client device 103b, a server 113, a content server 163, and an ad server 161. The first client device 103a and the second client device 103b may be referred to herein individually and collectively as client device 103. In the illustrated implementation, these entities of the system 100 may be communicatively coupled via a network 105. The system 100 may include other servers or devices not shown in FIG. 1 including, for example, a map server for providing map data.

Although FIG. 1 illustrates one network 105 coupled to the entities of the system 100, in practice one or more networks 105 can be connected to these entities. While FIG. 1 includes one calendar server 151, one social network server 155, one first client device 103a, one second client device 103b, one server 113, one content server 163, and one ad server 161, the system 100 may include one or more calendar servers 151, one or more social network servers 155, one or more client devices 103, one or more servers 113, one or more content servers 163, and one or more ad servers 161.

The network 105 can be a conventional type, wired or wireless, and may have numerous different configurations including a star configuration, a token ring configuration, or other configurations. Furthermore, the network 105 may include a local area network (LAN), a wide area network (WAN) (e.g., the Internet), or other interconnected data paths across which multiple devices may communicate. In some implementations, the network 105 may be a peer-to-peer network. The network 105 may also be coupled to or include portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, WAP, e-mail, etc. In some implementations, the network 105 may include a global positioning system (GPS) satellite for providing GPS navigation to the client devices 103a and 103b. The network 105 may be a mobile data network such as third-generation (3G), fourth-generation (4G), long-term evolution (LTE), Voice-over-LTE (“VoLTE”) or any other mobile data network or combination of mobile data networks.

In some implementations, an ad monetization application 115a can be operable on the first client device 103a. The ad monetization application 115a may include an ad targeting module 117a and an ad delivery module 119a. The first client device 103a may be a computing device that includes a memory and a processor, for example, a laptop computer, a desktop computer, a tablet computer, a mobile telephone, a personal digital assistant (“PDA”), a mobile e-mail device, a portable game player, a portable music player, a television with one or more processors embedded therein or coupled thereto, or another electronic device capable of accessing the network 105. In some implementations, the ad monetization application 115a may act in part as a thin-client application that may be stored on the first client device 103a and in part as components that may be stored on one or more of the server 113 and the second client device 103b. In the illustrated implementation, the first client device 103a is communicatively coupled to the network 105 via a signal line 108. A first user 125a may interact with the first client device 103a via a signal line 124.

In some implementations, an ad monetization application 115b can be operable on the second client device 103b. The ad monetization application 115b may include an ad targeting module 117b and an ad delivery module 119b. The second client device 103b can be a mobile client device. For example, the second client device 103b can be one of a vehicle (e.g., an automobile, a bus, an airplane), a bionic implant, or any other mobile system including non-transitory computer electronics. In some implementations, the second client device 103b may include a computing device that includes a memory and a processor. In the illustrated implementation, the second client device 103b is communicatively coupled to the network 105 via a signal line 118. A second user 125b may interact with the second client device 103b via a signal line 126.

In some implementations, the first user 125a and the second user 125b (also referred to individually and collectively as user 125) can be the same user 125 that may interact with both the first client device 103a and the second client device 103b. For example, the user 125 can be a driver that operates the second client device 103b (e.g., a vehicle) and the first client device 103a (e.g., a smartphone). In another example, the user 125 can be a passenger onboard in the vehicle. In some other implementations, the first user 125a and the second user 125b may be different users 125 that interact with the first client device 103a and the second client device 103b respectively.

In some implementations, the second client device 103b may include one or more sensors (not shown in FIG. 1). Example sensors may include, but are not limited to, a navigation sensor (e.g., a global positioning system (GPS) sensor), an infrared detector, a motion detector, a thermostat, a sound detector, and any other type of sensors. For example, the second client device 103b may include sensors for measuring one or more of a current time, a location (e.g., a latitude, longitude, and altitude of a location), an acceleration of a vehicle, a velocity of a vehicle, and a fuel tank level, etc. The sensors may generate sensor data describing the measurements and send the sensor data to the ad monetization application 115b.

In some implementations, the sensor may include a motion detector sensor, a proximity sensor, an infrared detector or any other sensor configured to determine that a button has been pressed. For example, the sensor may be configured to determine an occurrence of a button press event. The sensor may detect that the button has been selected and determine the occurrence of the button press event. The button press event may be configured to trigger performance of an action.

In some implementations, the GPS sensor may determine the geographic location of the second client device 103b and the advertisements provided to the second client device 103b may be based in part on the geographic location of the second client device 103b. For example, if the second client device 103b is proximate to a particular store, the second client device 103b may receive an advertisement for that particular store.

In some implementations, the second client device 103b may include a content application 121, a voice recognition system 123, a microphone 127, and any other suitable components (e.g., a display device, a touch screen, a speaker system, etc.). These components of the second client device 103b are described below in more detail.

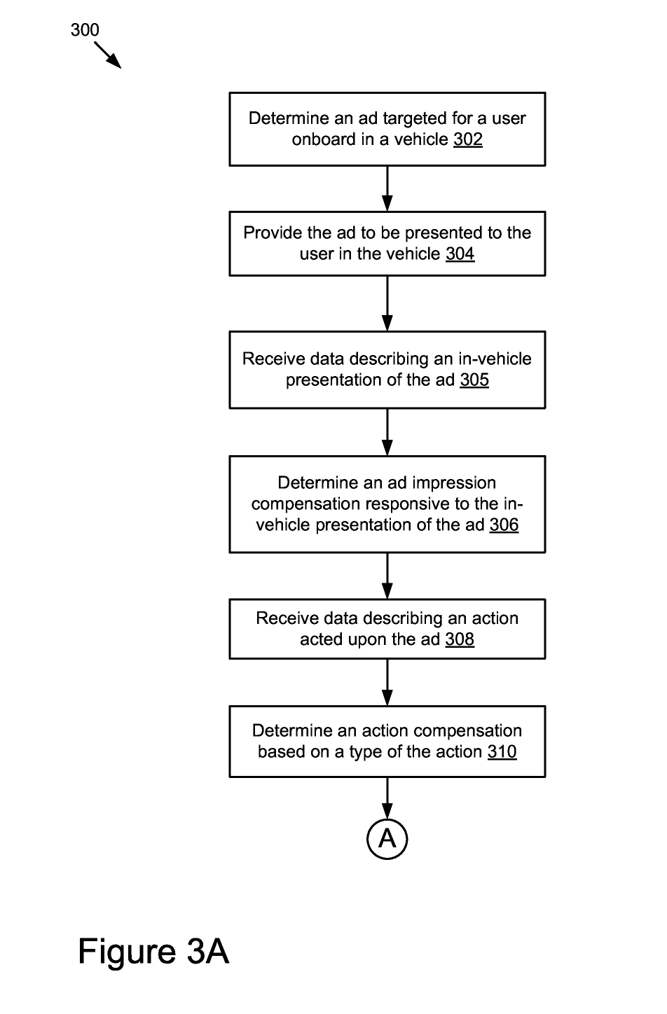

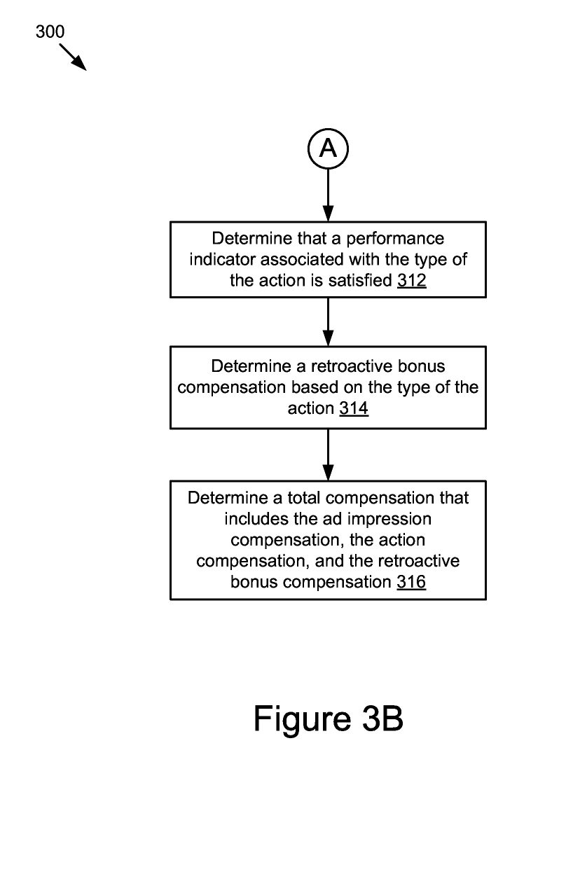

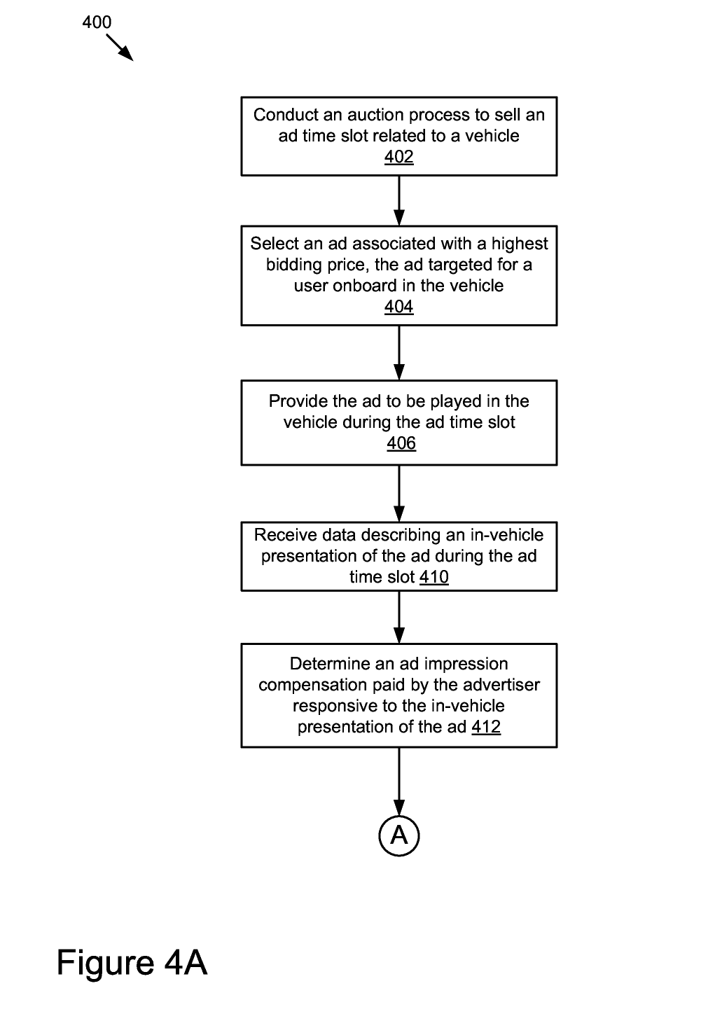

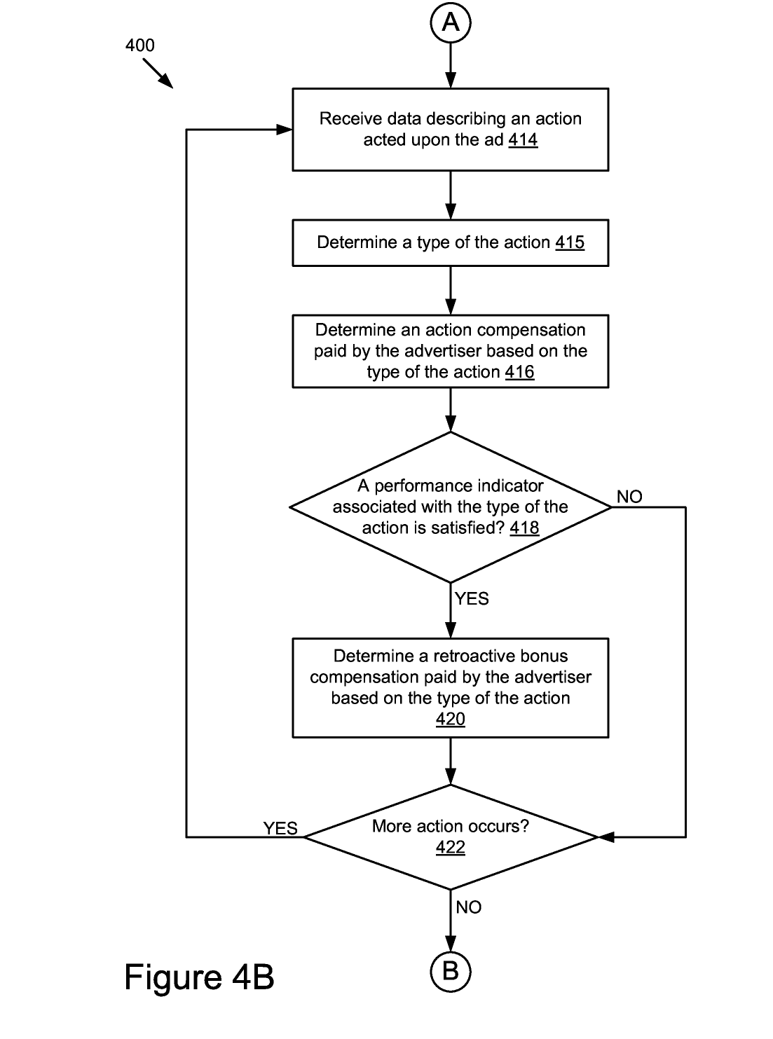

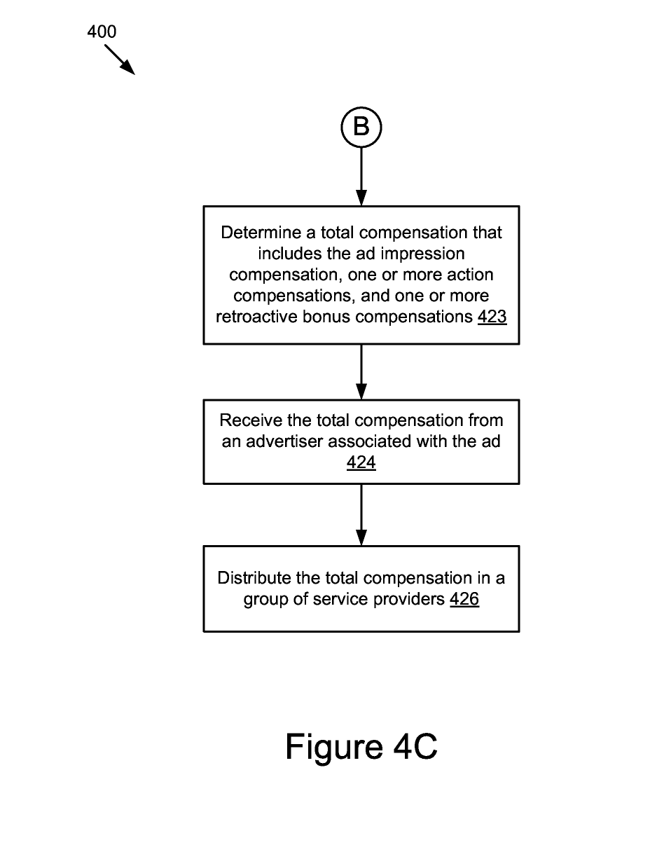

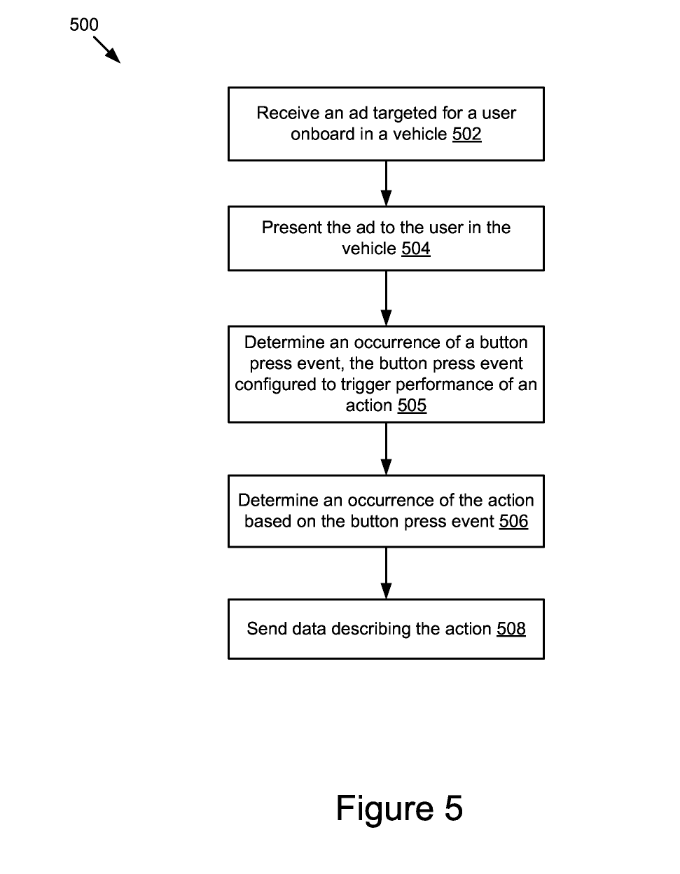

In some implementations, the second client device 103b may include a processor-based computing device programmed to perform one or more blocks of the methods 300 and 400 described below with reference to FIGS. 3A, 3B, 4A, 4B, and 4C. For example, the second client device 103b may include a special-purpose computing device programmed to perform one or more blocks of the methods 300 and 400 described below with reference to FIGS. 3A-3B and 4A-4C. Alternatively or additionally, the second client device 103b may include a special-purpose computing device programmed to perform one or more blocks of the method 500 described below with reference to FIG. 5.

In some implementations, an ad monetization application 115c can be operable on the server 113. The ad monetization application 115c may include an ad targeting module 117c and an ad delivery module 119c. The server 113 can be a hardware server that includes a processor, a memory, and network communication capabilities. In the illustrated implementation, the server 113 is coupled to the network 105 via a signal line 114. The server 113 may send and receive data to and from other entities of the system 100 via the network 105. The server 113 may include a storage device 141 for storing data to provide the functionality described herein. The storage device 141 is described below in more detail.

The ad monetization application 115 (e.g., the ad monetization application 115a, 115b, or 115c) can be a system that monetizes ad presentations in mobile client devices. The ad monetization application 115 may include an ad targeting module 117 and an ad delivery module 119. In some implementations, the ad monetization application 115 can be implemented using hardware including a field-programmable gate array (“FPGA”) or an application-specific integrated circuit (“ASIC”). In some other implementations, the ad monetization application 115 can be implemented using a combination of hardware and software. Components of the ad monetization application 115 may be stored in a combination of the devices and servers, or in one of the devices or servers. For example, the ad targeting module 117 may be stored in the server 113 while the ad delivery module 119 may be stored in the first client device 103a or the second client device 103b. Alternatively, both the ad targeting module 117 and the ad delivery module 119 may be stored in the second client device 103b.

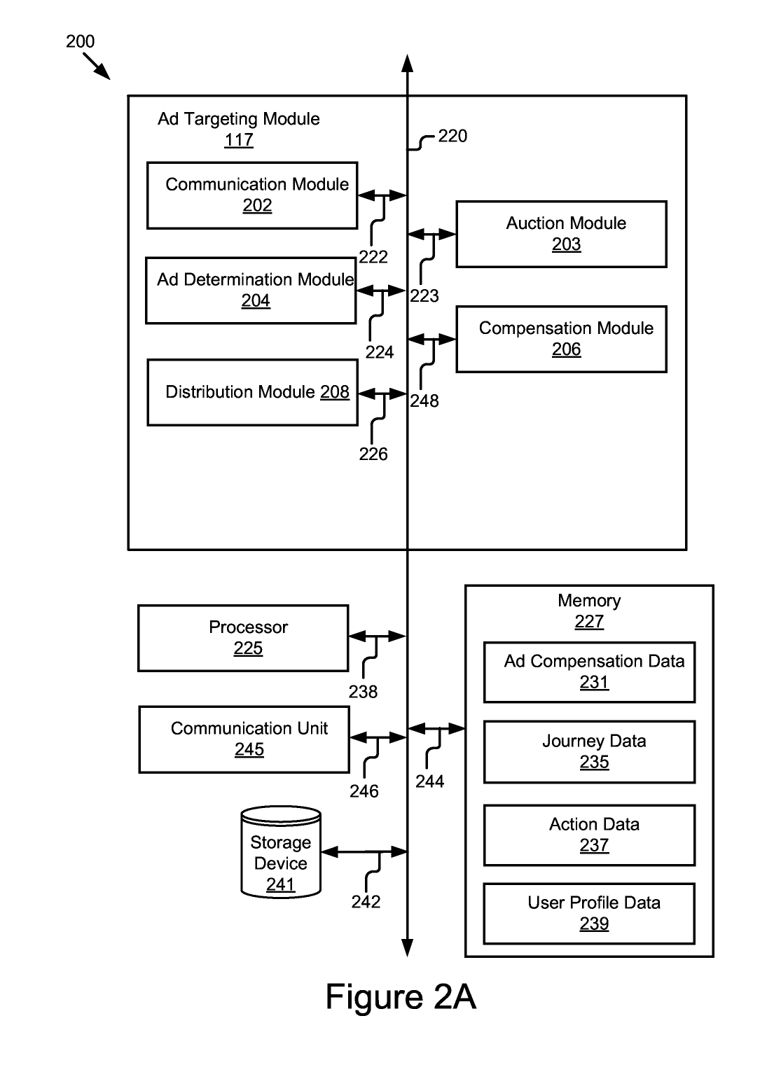

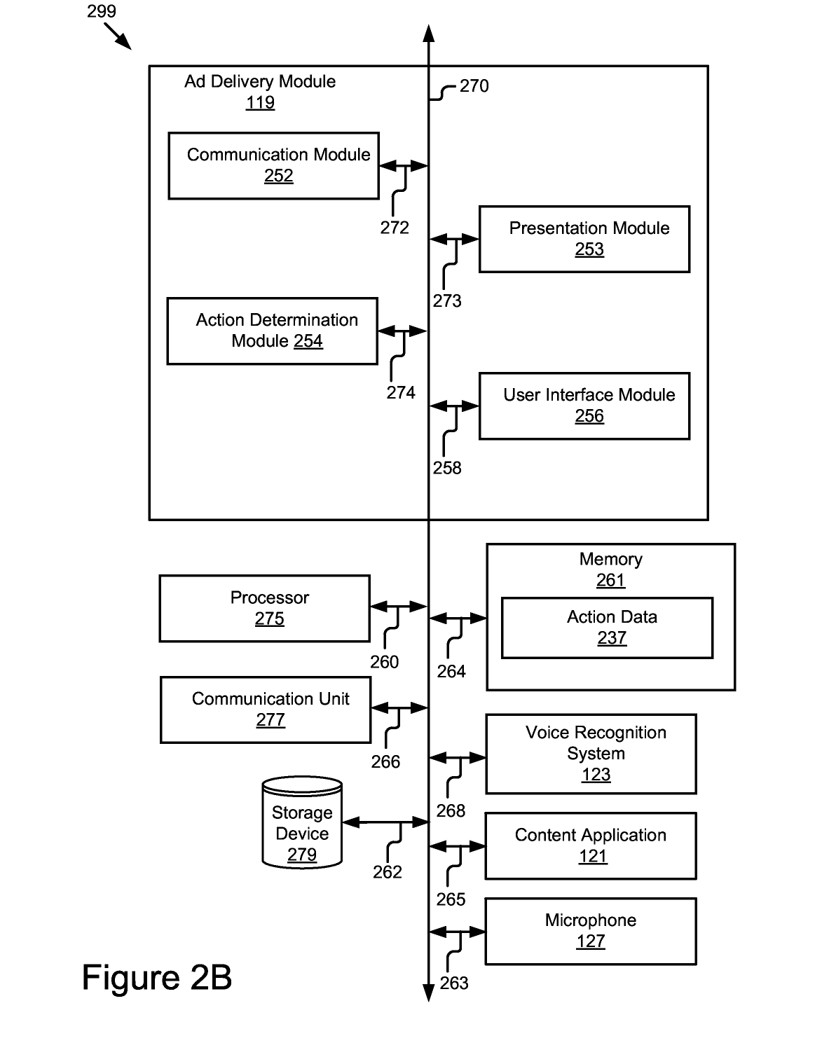

The ad targeting module 117 may determine an ad targeted for a user, provide the ad to the ad delivery module 119 for presenting the ad to the user, and collect revenue generated from the presentation of the ad. The ad targeting module 117 is described below in more detail with reference to FIGS. 2A, 3A-3B, and 4A-4C The ad delivery module 119 may receive the ad from the ad targeting module 117 and present the ad to the user present in the mobile client device such as a vehicle. The ad delivery module 119 is described below in more detail with reference to FIGS. 2B and 5.

The content application 121 can be an application that provides content to a user. For example, the content application 121 may include a music application, a radio application, a video streaming application, a news application, a podcast application, or any other suitable content application. In some implementations, the content application 121 may receive a content stream from the content server 163 and may play the content stream to the user. Alternatively or additionally, the content stream may be inserted with an ad by the ad delivery module 119, and the content application 121 may play the inserted ad along with the content stream.

The content stream (or the ad) may include one or more of audio content and visual content. In some implementations, the content application 121 can play the audio content and the visual content using corresponding hardware included in the client device 103, e.g., an audio reproduction system for reproducing the audio content and a video display for presenting the visual content. Example audio content may include, but is not limited to, podcasts, voice recordings, tape recordings, compact discs (CDs), music, audio tracks for ads, audio radio programs, video soundtracks, and other audio content, etc. Example visual content may include, but is not limited to, maps, animations, images, videos, video tracks, and images for ads (e.g., ad text, ad banners, ad videos, etc.), etc.

The voice recognition system 123 can be a system capable of interpreting a verbal input from a user. For example, the microphone 127 may capture a verbal input from the user and may send the verbal input to the voice recognition system 123 for interpretation. The voice recognition system 123 may generate an interpretation result that may trigger performance of one or more actions as described below in more detail.

The storage device 141 can be a non-transitory storage medium that stores data for providing the functionality described herein. The storage device 141 may be a dynamic random access memory (DRAM) device, a static random access memory (SRAM) device, flash memory, or some other memory devices. In some implementations, the storage device 141 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The calendar server 151 can be a hardware server that includes a processor, a memory, and network communication capabilities. In the illustrated implementation, the calendar server 151 is coupled to the network 105 via a signal line 152. The calendar server 151 may send and receive data to and from other entities of the system 100 via the network 105. For example, the calendar server 151 may send data describing a user's calendar to the ad targeting module 117 with permission from the user.

The social network server 155 can be a hardware server that includes a processor, a memory, and network communication capabilities. In the illustrated implementation, the social network server 155 is coupled to the network 105 via a signal line 154. The social network server 155 may send and receive data to and from other entities of the system 100 via the network 105. The social network server 155 may include a social network application 157. A social network can be a type of social structure where the users 125 may be connected by a common feature. The common feature may include relationships/connections, e.g., friendship, family, work, an interest, etc. The common features may be provided by one or more social networking systems including explicitly defined relationships and relationships implied by social connections with other online users, where the relationships form a social graph. In some examples, the social graph can reflect a mapping of these users and how they can be related.

The ad server 161 can serve ad content to the server 113, the content server 163, and the client device 103. In the illustrated implementation, the ad server 161 is coupled to the network 105 via a signal line 162. The ad server 161 may include an ad inventory for storing the ad content. For example, the ad server 161 can receive ad identification data (e.g., an ad ID) from the ad targeting module 117, retrieve an ad matching the ad identification data from the ad inventory, and send the ad to the ad delivery module 119 or the content application 121 for presenting the ad to the user.

The content server 163 can receive and send data to and from one or more of the server 113, the client device 103, and the ad server 161. For example, the content server 163 may serve digital content to the content application 121 upon request. In a further example, the content server 163 may provide radio programs, TV programs, videos, maps, or other digital content to the content application 121 for presentation to the user associated with the client device 103. In the illustrated implementation, the content server 163 is coupled to the network 105 via a signal line 164.

### Example Ad Targeting Module

Referring now to FIG. 2A, an example of the ad targeting module 117 is shown in more detail. FIG. 2A is a block diagram of a computing device 200 that includes the ad targeting module 117, a processor 225, a communication unit 245, a storage device 241, and a memory 227 according to some examples. The components of the computing device 200 are communicatively coupled by a bus 220. In some implementations, the computing device 200 can be one of the server 113, the first client device 103a, the second client device 103b, and any other entity of the system 100 in FIG. 1.

In some embodiments, the computing device 200 is an electronic device including hardware programmed to perform one or more steps of the methods 300, 400 described below with reference to FIGS. 3A, 3B, 4A, 4B and 4C.

The processor 225 may include an arithmetic logic unit, a microprocessor, a general-purpose controller, or some other processor array to perform computations and provide electronic display signals to a display device. The processor 225 is coupled to the bus 220 for communication with the other components via a signal line 238. The processor 225 processes data signals and may include various computing architectures including a complex instruction set computer (CISC) architecture, a reduced instruction set computer (RISC) architecture, or an architecture implementing a combination of instruction sets. Although FIG. 2A includes a single processor 225, multiple processors 225 may be included. Other processors, operating systems, sensors, displays, and physical configurations may be possible.

The processor 225 may be programmed to perform one or more steps of the methods 300, 400 described below with reference to FIGS. 3A, 3B, 4A, 4B and 4C. The processor 225 may include a special purpose processor programmed to perform one or more steps of the methods 300, 400 described below with reference to FIGS. 3A, 3B, 4A, 4B and 4C. the processor 225 may not be an element of a general purpose computer. For example, the processor 225 may be an element of a special purpose computer configured to provide some or all of the functionality described with reference to FIGS. 1, 2A, 3A, 3B, 4A, 4B, 4C, 6A and 6B.

The memory 227 stores instructions or data that may be executed by the processor 225. The memory 227 is coupled to the bus 220 for communication with the other components via a signal line 244. The instructions or data may include code for performing the techniques described herein. The memory 227 may be a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 2A, the memory 227 may store ad compensation data 231, journey data 235, action data 237, and user profile data 239. The ad compensation data 231 associated with an ad may include data describing various ad compensations paid by an advertiser. Example ad compensations associated with an ad may include, but are not limited to, an ad impression compensation, an action compensation, a retroactive bonus compensation, and other compensations related to the ad. The ad compensations are described below in more detail.

The journey data 235 may include data describing historical journeys taken by a user or a mobile client device (e.g., a vehicle). For example, the journey data 235 includes data describing one or more of a start point, an end point, a departure time from the start point, an arrival time at the end point, a route, a journey duration, a direction, and other journey context data associated with a journey taken by the user or the mobile client device.

The action data 237 associated with an ad may include data describing one or more actions being triggered responsive to a presentation of the ad. In some implementations, the one or more actions may be performed by a user presented with the ad. Alternatively, the one or more actions may be performed by one or more applications (e.g., a navigation application, a phone call application, etc.) responsive to a button press event and one or more instructions (e.g., verbal instructions) from the user.

Example actions may include, but are not limited to, providing the user with navigation instructions to a location related to the ad (e.g., a physical address mentioned in the ad, a physical address of a local store that may sell a product or provide a service advertised in the ad), calling a phone number related to the ad (e.g., calling a phone number mentioned in the ad), retrieving review information related to the product or the service mentioned in the ad, automatically purchasing the product or the service mentioned in the ad from an online store using an online shopping account associated with the user, visiting a local store that may sell the product or provide the service, making a purchase of the product or the service from the local store, automatically downloading a software program product (e.g., a software application, or “App”) mentioned in the digital ad from an online store, and digitally storing a digital coupon (e.g., a barcode that can be used at a store to make the purchase) that is mentioned in the digital ad. In some implementations, the online shopping account may store payment information and shipping information associated with the user so that the user may purchase the product or the service online by pressing a control button on a steering wheel of a vehicle or a soft button on a head unit of the vehicle, providing a purchase verbal instruction, or both.

The user profile data 239 may include data describing user profiles. For example, the user profile data 239 associated with a user includes a user name, an e-mail address, user preferences, hobbies, interests, education, work experience, and other demographic data describing the user. In some implementations, the user profile data 239 may include an identifier identifying a mobile client device operated by the user. For example, the user profile data 239 may include a vehicle identification number (VIN) of a vehicle driven by the user. Other example user profile data is possible.

The communication unit 245 may transmit and receive data to and from at least one of the client devices 103, the server 113, the ad server 161, the content server 163, the calendar server 151, the social network server 155, and any other entities of the system 100. The communication unit 245 is coupled to the bus 220 via a signal line 246. In some implementations, the communication unit 245 may include a port for direct physical connection to the network 105 or to another communication channel. For example, the communication unit 245 includes a USB, SD, CAT-5, or similar port for wired communication with the client devices 103 or the server 113. In some implementations, the communication unit 245 may include a wireless transceiver for exchanging data with the client devices 103 or other communication channels using one or more wireless communication methods, including IEEE 802.11, IEEE 802.16, BLUETOOTH®, or another suitable wireless communication method.

In some implementations, the communication unit 245 may include a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 245 may include a wired port and a wireless transceiver. The communication unit 245 may also provide other conventional connections to the network 105 for distribution of files or media objects using standard network protocols including TCP/IP, HTTP, HTTPS, and SMTP, etc.

The storage device 241 can be a non-transitory storage medium that stores data for providing the functionality described herein. The storage device 241 may include a similar structure and provide similar functionalities as the storage device 141 of FIG. 1, and similar description will not be repeated here. The storage device 241 is communicatively coupled to the bus 220 via a signal line 242. The storage device 241 may store data that was temporarily stored in the memory 227.

In the illustrated implementation shown in FIG. 2A, the ad targeting module 117 includes a communication module 202, an auction module 203, an ad determination module 204, a compensation module 206, and a distribution module 208. These components of the ad targeting module 117 are communicatively coupled to each other via the bus 220.

In some implementations, components of the ad targeting module 117 can be stored in a single server or device. In some other implementations, components of the ad targeting module 117 can be distributed and stored across multiple servers or devices. For simplicity and convenience purpose, the various components of the ad targeting module 117 in FIG. 2A are described below with reference to a vehicle, which may represent an example of a mobile client device. However, the description is not intended to limit the scope of the disclosure, and the description is also applicable to other examples of mobile client devices. Furthermore, the separation of various components, modules, and servers in the implementations described herein should not be understood as requiring such separation in all implementations, and in some implementations the described components, modules, devices, or servers can generally be integrated together in a single component, module, device, or server.

In some implementations, each component of the ad targeting module 117 (e.g., the module 202, 203, 204, 206, or 208) can be stored in the memory 227 of the computing device 200 and can be accessible and executable by the processor 225. Each component of the ad targeting module 117 may be adapted for cooperation and communication with the processor 225 and other components of the computing device 200 via the bus 220.

The communication module 202 can be software including code and routines for handling communications between the ad targeting module 117 and other components of the computing device 200. The communication module 202 may be coupled to the bus 220 via a signal line 222. The communication module 202 may send and receive data, via the communication unit 245, to and from one or more of the client device 103, the server 113, the calendar server 151, the social network server 155, the ad server 161, and the content server 163 depending upon where the ad targeting module 117 may be stored. For example, the communication module 202 may receive, via the communication unit 245, calendar data associated with a user from the calendar server 151 and may send the calendar data to the ad determination module 204.

In some implementations, the communication module 202 may receive data from components of the ad targeting module 117 and may store the data in one or more of the storage device 241 and the memory 227. For example, the communication module 202 may receive data describing an ad compensation associated with an ad from the compensation module 206 and may store the data in the storage device 241 or the memory 227. In some implementations, the communication module 202 may retrieve data from the storage device 241 or the memory 227 and may send the data to one or more components of the ad targeting module 117. For example, the communication module 202 may receive the journey data 235 from the memory 227 and may send the journey data 235 to the ad determination module 204. Alternatively or additionally, the communication module 202 may also handle communications between components of the ad targeting module 117.

The auction module 203 can be software including routines for conducting an auction process to sell an ad time slot so that an ad with a highest bidding price may be presented to a user present in a vehicle during the ad time slot. The auction process may create a way of determining a fair market value for presenting ads to a particular user at particular times of a day or at particular geographic locations. The auction module 203 may be coupled to the bus 220 via a signal line 223.

In some implementations, the auction module 203 may receive sensor data from one or more sensors mounted on the vehicle and may determine a status of the vehicle based on the sensor data. The status of the vehicle may include, but is not limited to, a location of the vehicle, a fuel level in a fuel tank of the vehicle, a tire state (e.g., a flat tire), a battery state, and any other states related to one or more parts of the vehicle. For example, the auction module 203 may receive GPS data from a GPS sensor and may determine a current location of the vehicle based on the GPS data. In another example, the auction module 203 may receive sensor data from a sensor that monitors the fuel tank in the vehicle and may determine a fuel level in the fuel tank based on the sensor data.

In some implementations, the auction module 203 may receive calendar data associated with the user from the calendar server 151. The calendar data may describe one or more appointments associated with the user, one or more locations for the one or more appointments, and one or more time schedules for the one or more appointments. Alternatively or additionally, the auction module 203 may receive social network data associated with the user from the social network server 155. The social network data may include data describing: likes, dislikes, and interests associated with the user; comments, acknowledgements, and posts published by the user in a social network; posts and videos accessed by the user through the social network; and any other social data associated with the user.

Alternatively or additionally, the auction module 203 may receive journey data associated with the user or the vehicle. The journey data may include data describing locations visited by the user at different times of a day as a matter of a routine and an identification number of the vehicle. The identification number of the vehicle may serve as a unique identifier for identifying the user or the vehicle and for tracking ads that have been delivered to the user. Alternatively or additionally, the auction module 203 may receive action data describing one or more actions performed by the user in response to an ad being presented to the user. For example, the action data may describe a list of products or services purchased by the user in the past after the user was presented with the related ads.

The auction module 203 may share data with one or more advertisers upon approval from the user. The shared data may include one or more of the status of the vehicle, the calendar data associated with the user, the social network data associated with the user, the journey data, and the action data. The auction module 203 may send a bidding request for an ad time slot to the one or advertisers so that the one or more advertisers may use the shared data to determine a bidding price for the ad time slot. The one or more advertisers may analyze the shared data and may bid for the ad time slot or different ad time slots based on: (1) analysis results of the shared data; and (2) products or services sold by the one or more advertisers.

In some implementations, each advertiser may determine a bidding price for presenting its ad to the user during the ad time slot in the vehicle based on one or more of: (1) products or services the user likes or has purchased in the past; (2) a geographic proximity between the current location of the vehicle and a location of the advertiser's business location; (3) types of ads that are effective on the user; (4) a time of the day; (5) a day of the week; and (6) the status of the vehicle. For example, if the status of the vehicle indicates that the fuel level in the vehicle may be lower than a predetermined level, a gas station advertiser may bid with a higher price for an approaching ad time slot in order to outbid other advertisers to get its gas station ad presented to the user in the approaching ad time slot. In another example, an advertiser that has a business location along a driving route of the vehicle may bid for an ad time slot so that the advertiser's ad may be presented to the user during the ad time slot before the user arrives at the advertiser's business location.

In some implementations, the auction module 203 may receive different bidding prices for the ad time slot from different advertisers. The auction module 203 may send the different bidding prices for the ad time slot to the ad determination module 204.

The ad determination module 204 can be software including routines for determining an ad to be presented to a user present in a vehicle during a particular ad time slot. The ad determination module 204 is communicatively coupled to the bus 220 via a signal line 224. In some implementations, the ad determination module 204 may receive data describing different bidding prices for the particular ad time slot from different advertisers. The ad determination module 204 may determine an ad associated with a highest bidding price to be presented to the user during the particular ad time slot. For example, the ad determination module 204 may select an advertiser that offers the highest bidding price and may determine to present an ad associated with the advertiser to the user during the particular ad time slot.

In some implementations, the ad determination module 204 may determine a status of the vehicle. For example, the ad determination module 204 may determine one or more of a location of the vehicle, a fuel level in a fuel tank of the vehicle, a tire state, a time of day, and any other states related to one or more parts of the vehicle. The ad determination module 204 may determine an ad to be presented to the user during a particular ad time slot based on the status of the vehicle. For example, if the status of the vehicle indicates that a level of windshield washer fluid in the vehicle is lower than a threshold, the ad determination module 204 may select an ad associated with an auto store that may sell windshield washer fluid.

In some implementations, the ad determination module 204 may receive calendar data associated with the user from the calendar server 151, social network data associated with the user from the social network server 155, user profile data associated with the user, journey data associated with the user or the vehicle, and action data describing one or more actions performed by the user. The ad determination module 204 may determine an ad to be presented to the user based on one or more of the calendar data, the social network data, the user profile data, the journey data, and the action data. For example, the ad determination module 204 may select an ad describing a deal in a store near a journey destination so that the ad may be presented to the user before the user arrives at the journey destination. In another example, assume that the user profile data indicates that the user likes a particular brand and the action data indicates that the user has purchased a product from the particular brand. The ad determination module 204 may select an ad related to the particular brand to be presented to the user.

The ad determination module 204 may send an ad identifier (ID) of the selected ad to the ad delivery module 119, causing the ad delivery module 119 to use the ad ID to retrieve the selected ad from the ad server 161 and to present the selected ad to the user during the particular time slot. Alternatively, the ad determination module 204 may retrieve the selected ad from the ad server 161 and may send the selected ad to the ad delivery module 119 for presenting the selected ad to the user during the particular time slot.

The compensation module 206 can be software including routines for determining one or more ad compensations associated with an ad. The compensation module 206 is communicatively coupled to the bus 220 via a signal line 248. In some implementations, the compensation module 206 may receive data describing that the ad has been presented to the user present in the vehicle from the ad delivery module 119. The compensation module 206 may determine an ad impression compensation paid by an advertiser associated with the ad as a return for presenting the ad to the user. The ad impression compensation may indicate a price that the advertiser may pay for a presentation of the ad to the user. For example, the ad determination module 204 may send an ad to the ad delivery module 119 so that the ad delivery module 119 may present the ad to the user during a particular ad time slot. The ad delivery module 119 may then send data describing the in-vehicle presentation (or in-vehicle impression) of the ad to the compensation module 206, causing the compensation module 206 to determine an ad impression compensation (e.g., $0.01 cents) for the in-vehicle presentation of the ad.

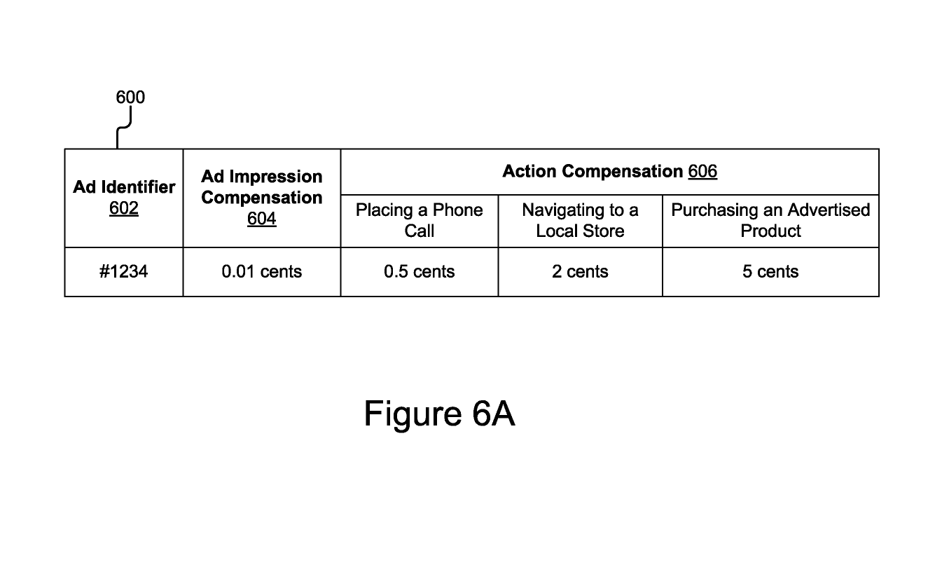

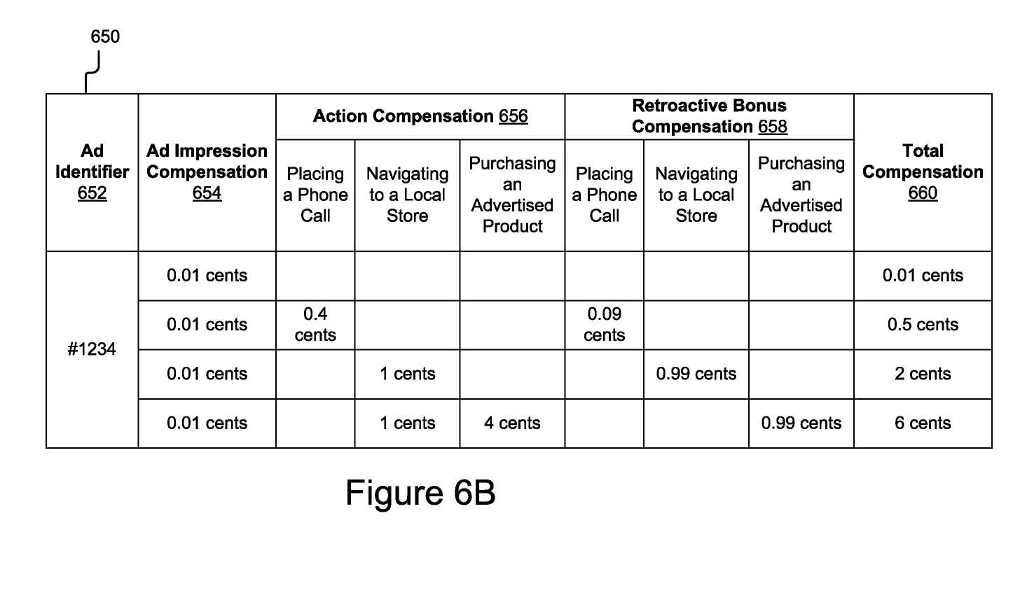

Additionally or alternatively, the compensation module 206 may receive data describing one or more actions being acted upon the ad. The compensation module 206 may verify an occurrence of the one or more actions and may determine one or more action types for the one or more actions. The compensation module 206 may determine one or more action compensations based on the one or more action types. An action compensation associated with an action may indicate a price that an advertiser may pay responsive to an occurrence of the action. Example compensation charts that may include compensations for different actions are illustrated in FIGS. 6A and 6B. In some implementations, while the ad is being presented to the user, the user may press a control button on a steering wheel or a control button on a panel or a head unit to trigger performance of the one or more actions. The user may also provide a verbal instruction that may be recorded by the microphone 127 and then interpreted by the voice recognition system 123 to facilitate performance of the one or more actions.

For example, the user may request a phone call application installed in the vehicle to call a business phone number mentioned in the ad by pressing the control button, providing a verbal instruction, or both. In this case, the ad delivery module 119 may determine an occurrence of a calling action being acted upon the ad and may send data describing the occurrence of the calling action to the compensation module 206. The compensation module 206 may verify the occurrence of the calling action by cross-referencing a call history of the vehicle with the business phone number in the ad. The compensation module 206 may determine an action compensation for the calling action so that the advertiser may pay for the occurrence of the calling action with an amount described in the action compensation.

In another example, the user may request a navigation application installed in the vehicle to provide driving instructions to a local store mentioned in the ad by pressing the control button, providing a verbal instruction, or both. The ad delivery module 119 may determine an occurrence of a navigation action being acted upon the ad and may send data describing the navigation action to the compensation module 206. In some embodiments, the compensation module 206 may verify the occurrence of an action based on sensor data detected by a sensor of the vehicle. The sensor data may describe the occurrence of the action. For example, the compensation module 206 may verify the occurrence of the navigation action by reviewing a journey history (e.g., a GPS navigation history) associated with the vehicle. The compensation module 206 may determine an action compensation for the navigation action so that the advertiser may pay for the occurrence of the navigation action with an amount included in the action compensation. Other examples of verifying the occurrence of an action based on sensor data are possible.

Additionally or alternatively, the user may make a purchase of a product or a service mentioned in the ad from the local store. The ad delivery module 119 may determine an occurrence of a purchase action being acted upon the ad and may send data describing the purchase action to the compensation module 206. The compensation module 206 may verify the purchase action by reviewing a payment history associated with the user (e.g., the user's credit card payment information upon approval from the user). The compensation module 206 may determine an action compensation for the purchase action so that the advertiser may pay for the occurrence of the purchase action with an amount included in the action compensation.

In yet another example, the user may request a shopping application installed in the vehicle to purchase a product or a service mentioned in the ad from an online store by pressing the control button, providing a verbal instruction, or both. The ad delivery module 119 may determine an occurrence of an online purchase action being acted upon the ad and may send data describing the online purchase action to the compensation module 206. The compensation module 206 may verify the online purchase action by reviewing a transaction history of an online account associated with the user or a payment history associated with the user. The compensation module 206 may determine an action compensation for the online purchase action so that the advertiser may pay for the occurrence of the online purchase action with an amount included in the action compensation.

In some implementations, the compensation module 206 may determine whether a performance indicator associated with a particular action may be satisfied for a campaign of the ad. A satisfaction of the performance indicator may indicate an effectiveness of the ad in triggering performance of the action. If the performance indicator associated with the action is satisfied, the compensation module 206 may determine a retroactive bonus compensation paid by the advertiser based on a type of the action. The performance indicator may be predetermined or pre-negotiated by the advertiser, an ad targeting service provider, or both.

For example, assume that a performance indicator associated with a purchase action in an ad campaign may require that at least 5% of users being presented with the ad have bought a product or service advertised in the ad. If 6% of users being presented with the ad have bought the advertised product or service, the compensation module 206 may determine a bonus compensation for the purchase action since the performance indicator associated with the purchase action is satisfied. The advertiser may pay the bonus compensation retroactively for each occurrence of the purchase action after the performance indicator is satisfied.

The retroactive bonus compensation may be considered as an example of a performance-based compensation, which may convey to the advertiser that the ad targeting module 117 (or, the ad targeting service provider) is motivated to provide an effective ad campaign for the ad. The retroactive bonus compensation may be used to retroactively increase an ad compensation based on performance of the ad campaign. For example, the retroactive bonus compensation may be considered as a reward for effectiveness of the ad campaign. Different types of actions, which may indicate different degrees of effectiveness of the ad campaign, may be associated with different retroactive bonus compensations. An example compensation chart that includes different retroactive bonus compensations for different actions is illustrated in FIG. 6B.

The compensation module 206 may determine a total compensation associated with a presentation of the ad in the vehicle. For example, the total compensation may include the ad impression compensation if no action occurs responsive to the ad being presented to the user. In another example, the total compensation may include the ad impression compensation and an action compensation if a particular action occurs responsive to the ad being presented to the user. In yet another example, the total compensation may include the ad impression compensation, an action compensation if a particular action occurs responsive to the ad being presented to the user, and a retroactive bonus compensation for the particular action if a performance indicator associated with the particular action is satisfied. The compensation module 206 may send data describing the total compensation to the distribution module 208.

The distribution module 208 can be software including routines for collecting an ad compensation from an advertiser and distributing the ad compensation among a group of service providers. The distribution module 208 is communicatively coupled to the bus 220 via a signal line 226. In some implementations, the distribution module 208 may receive data describing a total compensation associated with an ad from the compensation module 206. The ad may advertise a product or a service provided by an advertiser. The distribution module 208 may collect the total compensation from the advertiser and may distribute the total compensation within a group of service providers. The group of service providers may include an ad targeting service provider, an ad delivery service provider, and any other service provider that may participate in providing the ad to the user. The ad targeting service provider may operate or may control performance of the ad targeting module 117. The ad delivery service provider may operate or may control performance of the ad delivery module 119.

As described herein, the ad targeting module 117 may improve performance of a computer system by enabling the computer system to use various data to determine an effective ad for a user at a right time of a day to increase a likelihood that the user may make a purchase. By processing the various data, the computer system may determine an effective ad for the user in a faster and more effective way compared to doing so without knowledge of the various data. For example, the computer system may use one or more of a status of a vehicle (e.g., a location of the vehicle, a fuel level in a fuel tank of the vehicle, a tire state, a time of day, etc.), calendar data associated with the user, social network data associated with the user, user profile data associated with the user, journey data associated with the user or the vehicle, and action data describing one or more actions performed by the user to select an ad targeted for the user during an appropriate ad time slot. In this way, the selected ad may be customized for the user or the vehicle so that the user is more likely to perform one or more actions upon presentation of the ad.

The ad targeting module 117 may also improve the performance of the computer system by enabling the computer system to execute the auction module 203 so that the computer system may determine a fair market price for an ad presented in a vehicle through an open auction process. The open auction process may facilitate the computer system to determine pricing strategies for ads in the vehicle.

The ad targeting module 117 may also improve the performance of the computer system by enabling the computer system to execute the compensation module 206 so that the computer system may determine a performance of the ad based on different types of actions acted upon presentation of the ad. The computer system may then determine an ad compensation paid by the advertiser based on the performance of the ad. The different types of actions, which may indicate different degrees of effectiveness of the ad, may facilitate the computer system to determine an appropriate amount of compensation that the advertiser may pay for the ad.

### Example Ad Delivery Module

Referring now to FIG. 2B, an example of the ad delivery module 119 is shown in more detail. FIG. 2B is a block diagram of a computing device 299 that includes the ad delivery module 119, a processor 275, a communication unit 277, a storage device 279, a memory 261, the voice recognition system 123, the content application 121, and the microphone 127 according to some examples. The components of the computing device 299 are communicatively coupled by a bus 270. In some implementations, the computing device 299 can be one of the server 113, the first client device 103a, the second client device 103b, and any other entity of the system 100 in FIG. 1.

The processor 275, the communication unit 277, the storage device 279, and the memory 261 may provide functionalities similar to the processor 225, the communication unit 245, the storage device 241, and the memory 227 of FIG. 2A, respectively. Similar description for the processor 275, the communication unit 277, the storage device 279, and the memory 261 will not be repeated here. As illustrated in FIG. 2B, the memory 261 may store the action data 237 of FIG. 2A.

In some embodiments, the computing device 299 is an electronic device including hardware programmed to perform one or more steps of the method 500 described below with reference to FIG. 5.

Vehicles include one or more onboard vehicle computer systems. An onboard vehicle computer system may include a special purpose computing device programmed to provide functionality for the computer such as on-board diagnostics, sending and receiving data via the network 105, providing in-vehicle infotainment, etc. In some implementations, the system 299 may be an element of an onboard vehicle computer system that includes the processor 275. The processor 275 may be programmed to perform one or more steps of the method 500 described below with reference to FIG. 5. The processor 275 may include a special purpose processor programmed to perform one or more steps of the method 500 described below with reference to FIG. 5. Accordingly, the processor 275 may not be an element of a general purpose computer since the processor may be an element of a special purpose computer such as an onboard vehicle computer system. In some implementations, the processor 275 may be an element of a special purpose computer configured to provide some or all of the functionality described with reference to FIGS. 1, 2B and 5.

The processor 275 is communicatively coupled to the bus 270 via a signal line 260. The communication unit 277 is communicatively coupled to the bus 270 via a signal line 266. The storage device 279 is communicatively coupled to the bus 270 via a signal line 262. The memory 261 is communicatively coupled to the bus 270 via a signal line 264. The voice recognition system 123 is communicatively coupled to the bus 270 via a signal line 268. The content application 121 is communicatively coupled to the bus 270 via a signal line 265. The microphone 127 is communicatively coupled to the bus 270 via a signal line 263.

In the illustrated implementation shown in FIG. 2B, the ad delivery module 119 may include a communication module 252, a presentation module 253, an action determination module 254, and a user interface module 256. These components of the ad delivery module 119 are communicatively coupled to each other via the bus 270. For simplicity and convenience purpose, the various components of the ad delivery module 119 in FIG. 2B are described below with reference to a vehicle, which may represent an example of a mobile client device. However, the description is not intended to limit the scope of the disclosure, and the description is also applicable to other examples of mobile client devices.

In some implementations, each component of the ad delivery module 119 (e.g., the module 252, 253, 254, or 256) can be stored in the memory 261 of the computing device 299 and can be accessible and executable by the processor 275. Each component of the ad delivery module 119 may be adapted for cooperation and communication with the processor 275 and other components of the computing device 299 via the bus 270.

The communication module 252 can be software including code and routines for handling communications between the ad delivery module 119 and other components of the computing device 299. The communication module 252 may be coupled to the bus 270 via a signal line 272. The communication module 252 may send and receive data, via the communication unit 277, to and from one or more of the client device 103, the server 113, the calendar server 151, the social network server 155, the ad server 161, and the content server 163 depending upon where the ad delivery module 119 may be stored. For example, the communication module 252 may receive, via the communication unit 277, data describing an ad from the ad targeting module 117 and may send the data to the presentation module 253 for presenting the ad. In another example, the communication module 252 may receive data describing one or more actions determined by the action determination module 254 and may send the data to the ad targeting module 117.

In some implementations, the communication module 252 may receive data from components of the ad delivery module 119 and may store the data in one or more of the storage device 279 and the memory 261. In some implementations, the communication module 252 may retrieve data from the storage device 279 or the memory 261 and may send the data to one or more components of the ad delivery module 119.

The presentation module 253 can be software including routines for presenting an ad to a user present in a vehicle. The presentation module 253 is communicatively coupled to the bus 270 via a signal line 273. In some implementations, the presentation module 253 may receive data describing an ad targeted for the user present in the vehicle. The presentation module 253 may also receive data describing an ad time slot for presenting the ad. The presentation module 253 may incorporate the ad into a content stream being played in the vehicle so that the ad may be configured to be played to the user during the ad time slot. The presentation module 253 may play the ad in the vehicle during the ad time slot using one or more of a speaker system and a display device in the vehicle.

In some implementations, the content application 121 may play various digital content (e.g., music, video, radio program, podcast, etc.) in the vehicle using the speaker system, the display device, or both. The presentation module 253 may insert the ad into the digital content so that the ad may be configured to be played during the ad time slot. For example, the presentation module 253 may generate and provide a control signal to the content application 121. The control signal may control the insertion of the ad into the digital content. In some examples, the control signal may indicate to superimpose the ad over the digital content so that the digital content may be played in the background while the ad is played to the user during the ad time slot. The content application 121 may also display a visual portion of the ad on the head unit of the vehicle. In some examples, the control signal may indicate to play the ad during a break of the digital content. For example, the control signal may indicate to play the ad during a break between two songs.

The action determination module 254 can be software including routines for determining one or more actions that may occur in response to a presentation of an ad in a vehicle. The action determination module 254 is communicatively coupled to the bus 270 via a signal line 274. In some implementations, the action determination module 254 may detect an occurrence of a button press event that may trigger performance of one or more actions. For example, while the ad is being presented to the user, the user may press a control button to trigger performance of the one or more actions.

In some implementations, the control button may be a button on a steering wheel, which may allow for eyes-free user interactions. Implementations of the control button do not require modifications to existing hardware present in the steering wheel and may be realized by reprogramming an existing media control button on the steering wheel. For example, when an audio ad is being played in the vehicle, the media content being played may be paused. An existing rewind (RWD) button (or a fast forward (FWD) button) may be temporarily available for serving another purpose. Thus, the existing RWD button (or the FWD button) may be reprogrammed to serve a dual function that includes a rewinding function (or a fast forward function) during playing of the media content and a function of the control button described herein during a presentation of an ad. Alternatively or additionally, the control button may be a button on a panel or a head unit of the vehicle. One or more of the RWD and FWD buttons may include hardware buttons that are tangible and may be selected by a user.

The user may also provide a verbal instruction that may be recorded by the microphone 127 and then interpreted by the voice recognition system 123 to facilitate performance of the one or more actions. For example, the user may press the control button to activate the microphone 127 so that the microphone 127 may capture a verbal instruction provided by the user and may send the verbal instruction to the voice recognition system 123 for interpretation. The voice recognition system 123 may generate an interpretation result that may trigger one or more applications installed in the vehicle to perform the one or more actions. Example applications may include, but are not limited to, a navigation application, a phone call application, and a shopping application, etc. In this example, a press event of the control button may activate a speech recognition process to capture and interpret verbal instructions from the user and may also cause the one or more applications to perform the one or more actions automatically based on the verbal instructions. The control button may act as an agent that triggers performance of the one or more actions for the user.

The action determination module 254 may detect an occurrence of the one or more actions based at least in part on the occurrence of the button press event and the verbal instruction provided by the user. For example, the user may press the control button and may provide a verbal instruction to request a phone call application installed in the vehicle to call a business phone number mentioned in the ad. The action determination module 254 may determine an occurrence of a calling action acted upon the ad based on the button press event and the verbal instruction. The action determination module 254 may send data describing the calling action to the compensation module 206 of FIG. 2A.

In another example, the user may press the control button and may provide a verbal instruction to request a navigation application installed in the vehicle to provide driving instructions to a local store mentioned in the ad. The action determination module 254 may determine an occurrence of a navigation action acted upon the ad based on the button press event and the verbal instruction. Alternatively, the action determination module 254 may determine the occurrence of the navigation action based on navigation data received from the navigation application. For example, GPS data from a GPS sensor may indicate that the user has arrived at the local store, and the action determination module 254 may determine the occurrence of the navigation action from the GPS data. The action determination module 254 may send data describing the navigation action to the compensation module 206.

Additionally or alternatively, the user may make a purchase of a product or a service mentioned in the ad from the local store. The action determination module 254 may determine an occurrence of a purchase action based on a payment history associated with the user (e.g., the user's credit card payment information with approval from the user). The action determination module 254 may send data describing the purchase action to the compensation module 206.

In yet another example, the user may press the control button and may provide a verbal instruction to request a shopping application installed in the vehicle to purchase a product or a service mentioned in the ad from an online store. The user may register or log in to the shopping application using a shopping account that may store payment information and a mailing address of the user. The action determination module 254 may determine an occurrence of an online purchase action based on the button press event and the verbal instruction. Alternatively or additionally, the action determination module 254 may determine the occurrence of the online purchase action based on a payment history associated with the user (e.g., the user's credit card payment information) or a transaction history associated with the user's shopping account. The action determination module 254 may send data describing the online purchase action to the compensation module 206.

In still yet another example, the user may press the control button to trigger a retrieval of review information (e.g., customer reviews) related to a product or a service advertised in the ad from one or more web servers. The review information may be retrieved from one or more predetermined websites. Alternatively or additionally, the user may provide a verbal instruction to specify a particular website from which the review information may be retrieved.

In some implementations, the action determination module 254 may report the occurrence of the one or more actions to one or more of: (1) the ad targeting module 117 associated with an ad targeting service provider; (2) the advertiser associated with the ad; (3) the ad server 161; and (4) other service providers related to the provision of the ad.

The user interface module 256 can be software including routines for generating graphical data for providing user interfaces. The user interface module 256 may be coupled to the bus 270 via a signal line 258. In some implementations, the user interface module 256 may generate graphical data for providing a user interface to a user. The user interface module 256 may send the graphical data to the client device 103, causing the client device 103 to present the user interface to the user.

### Methods

Referring now to FIGS. 3A and 3B, an example of a method 300 for monetizing ad presentations in a mobile client device (e.g., a vehicle) is described. Turning to FIG. 3A, the ad determination module 204 may determine 302 an ad targeted for a user present in the vehicle. The ad determination module 204 may provide 304 the ad to the ad delivery module 119 so that the ad may be presented to the user in the vehicle. The communication module 202 or the compensation module 206 may receive 305 data describing an in-vehicle presentation of the ad from the ad delivery module 119. The compensation module 206 may determine 306 an ad impression compensation paid by an advertiser associated with the ad responsive to the in-vehicle presentation of the ad. The communication module 202 or the compensation module 206 may receive 308 data describing an action acted upon the ad. The compensation module 206 may determine 310 an action compensation paid by the advertiser based on a type of the action.

Turning to FIG. 3B, the compensation module 206 may determine 312 that a performance indicator associated with the type of the action is satisfied. The compensation module 206 may determine 314 a retroactive bonus compensation paid by the advertiser based on the type of the action. The compensation module 206 may determine 316 a total compensation paid by the advertiser. The total compensation may include the ad impression compensation, the action compensation, and the retroactive bonus compensation.

In some embodiments, the method 300 may also include selecting, by the ad determination module 204, the digital ad based in part on one or more of: first historical actions performed by the user (e.g., a driver) currently onboard in the vehicle or other users (e.g., other drivers); second historical actions performed for the digital ad or other digital ads; third historical actions performed for a current category of digital ads that belong to the same category as the digital ad; and user data associated with the user (e.g., driver data associated with the current driver) identified using a user identification module.

In some embodiments, the method 300 may also include determining, by the compensation module 206, the action compensation based in part on one or more of: first historical actions performed by the user (e.g., a driver) currently onboard in the vehicle or other users (e.g., other drivers); second historical actions performed for the digital ad or other digital ads; third historical actions performed for a current category of digital ads that belong to the same category as the digital ad; and user data associated with the user (e.g., driver profile data associated with the current driver) identified using a user identification module.

In some embodiments, the determined digital ad may be supplemented with a piece of audio content that conveys a call-to-action message (e.g., an audio message that may be played in addition to the digital ad to the user and intended to motivate the user to perform the action). For example, the call-to-action message may describe “press the rewind button on the steering wheel to navigate to the store now.” The method 300 may also include determining, by the ad determination module 204, the audio content that conveys the call-to-action message based on permissible actions that can be performed on the digital ad. For example, the ad determination module 204 may determine the audio content that conveys the call-to-action message based on actions available to be performed on the digital ad. The method 300 may also include providing, by the ad determination module 204, the audio content to be presented to the user in the vehicle along with the digital ad. The communication module 202 or the compensation module 206 may receive data describing the in-vehicle presentation of the call-to-action message and may determine the ad impression compensation or the action compensation responsive to the in-vehicle presentation of the call-to-action message.

FIGS. 4A-4C are flowcharts of another example method 400 for monetizing ad presentations in a mobile client device (e.g., a vehicle) according to some implementations. Referring to FIG. 4A, the auction module 203 may conduct 402 an auction process to sell an ad time slot related to a vehicle to one or more advertisers. Each of the one or more advertisers may determine and send a bidding price for the ad time slot to the auction module 203, causing the auction module 203 to forward a respective bidding price from each advertiser to the ad determination module 204. The ad determination module 204 may select 404 an ad associated with a highest bidding price. For example, the ad determination module 204 may select an ad from an advertiser that offers the highest bidding price for the ad time slot. The selected ad may be targeted for a user present in the vehicle. The ad determination module 204 may provide 406 the ad to be played in the vehicle during the ad time slot. The communication module 202 or the compensation module 206 may receive 410 data describing an in-vehicle presentation of the ad during the ad time slot. The compensation module 206 may determine 412 an ad impression compensation paid by the advertiser associated with the ad responsive to the in-vehicle presentation of the ad.

Referring to FIG. 4B, the communication module 202 or the compensation module 206 may receive 414 data describing an action acted upon the ad. The compensation module 206 may determine 415 a type of the action. For example, the compensation module 206 may determine whether the action may be one of a calling action, a navigation action, a purchase action, or another suitable action. The compensation module 206 may determine 416 an action compensation paid by the advertiser based on the type of the action. Different actions may be associated with different action compensations. The compensation module 206 may determine 418 whether a performance indicator associated with the type of the action is satisfied. If the performance indicator associated with the type of the action is satisfied, the method 400 proceeds to block 420. Otherwise, the method 400 proceeds to block 422.

At block 420, the compensation module 206 may determines a retroactive bonus compensation paid by the advertiser based on the type of the action. The compensation module 206 may determine 422 whether another action occurs upon the presentation of the ad. If another action occurs, the method 400 returns to block 414. Otherwise, the method 400 proceeds to block 423 of FIG. 4C.

Referring to FIG. 4C, the compensation module 206 may determine 423 a total compensation paid by the advertiser. The total compensation may include the ad impression compensation, one or more action compensations associated with one or more actions, and one or more retroactive bonus compensations associated with the one or more actions. The communication module 202 or the distribution module 208 may receive 424 the total compensation from the advertiser associated with the ad. The distribution module 208 may distribute 426 the total compensation within a group of service providers. The group of service providers may include an ad targeting service provider, an ad delivery service provider, and any other service provider related to the provision of the ad.

FIG. 5 is a flowchart of an example method 500 for delivering an ad to a user according to some implementations. The communication module 252 or the presentation module 253 may receive 502 an ad targeted for the user present in a vehicle. The presentation module 253 may present 504 the ad to the user in the vehicle. The action determination module 254 may determine 505 an occurrence of a button press event. The button press event may be configured to trigger performance of an action. The action determination module 254 may determine 506 an occurrence of the action based on the button press event. The action determination module 254 or the communication module 252 may send 508 data describing the action to the compensation module 206.

FIGS. 6A and 6B are graphic representations illustrating example ad compensation charts 600 and 650 according to some implementations. Although ad compensations are listed using U.S. currency in the ad compensation charts 600 and 650, other types of currency are possible. The ad compensations may vary based on a fair market value or a negotiation result between an advertiser and an ad targeting service provider. As described below in more detail, a highest ad compensation may be received responsive to a user making a purchase. As a result, the ad targeting service provider configured to operate or control operations of the ad targeting module 117 may be motivated to deliver ads at an appropriate time to increase a likelihood that a user makes a purchase. For example, if a store is located beside a traffic light, the ad targeting module 117 may instruct the ad delivery module 119 to present an ad related to the store to the user before the user's vehicle approaches the traffic light to increase a likelihood that the user may navigate to the conveniently located store and make a purchase.

Referring to FIG. 6A, the ad compensation chart 600 may include an ad identifier 602 that identifies an ad “#1234,” an ad impression compensation 604 associated with the ad (e.g., 0.01 cents per ad impression), and action compensations 606 associated with different types of actions for the ad. The action compensations 606 may include a first action compensation for a calling action (e.g., 0.5 cents for placing a phone call to a business number related to the ad), a second action compensation for a navigation action (e.g., 2 cents for navigating to a local store related to the ad), and a third action compensation for a purchase action (e.g., 5 cents for purchasing a product or service advertised in the ad). The purchase action may occur at a brick and mortar store or an online store.

In some implementations, the ad targeting module 117 operated by or controlled by the ad targeting service provider may determine to present the ad “#1234” to a user in a vehicle. The ad targeting module 117 may send the ad to the ad delivery module 119 operated by or controlled by an ad delivery service provider. The ad delivery module 119 may be configured to deliver the ad to the user in the vehicle. Each time the ad is presented to the user, the ad delivery module 119 may notify the ad targeting module 117 of the presentation. The ad targeting module 117 may determine that an advertiser associated with the ad may need to pay the ad targeting service provider an amount of the ad impression compensation 604 (e.g., 0.01 cents) per ad impression.

If the user presses a control button after being presented with the ad, the ad delivery module 119 may determine an occurrence of an action and may notify the ad targeting module 117 of the action. If the action includes a calling action, the ad targeting module 117 may determine that the advertiser associated with the ad may need to pay the ad targeting service provider an amount of the first action compensation (e.g., 0.5 cents) for the calling action. Alternatively, if the action includes a navigation action, the ad targeting module 117 may determine that the advertiser associated with the ad may need to pay the ad targeting service provider an amount of the second action compensation (e.g., 2 cents) for the navigation action. Alternatively, if the action includes a purchase action, the ad targeting module 117 may determine that the advertiser associated with the ad may need to pay the ad targeting service provider an amount of the third action compensation (e.g., 5 cents) for the purchase action. The advertiser pays more for the purchase action than the calling action and the navigation action. The ad targeting service provider may share the ad compensation received from the advertiser with the ad delivery service provider.

The pricing structure in the ad compensation chart 600 may be configured to incentivize the ad targeting service provider and the ad delivery service provider to determine and present an ad at a best time so that the user is more likely to make a purchase. For example, the ad may be personalized and presented to the user when making a purchase of a product is easy and convenient for the user.

Referring to FIG. 6B, the ad compensation chart 650 may include an ad identifier 652 that identifies an ad “#1234”, an ad impression compensation 654 associated with the ad (e.g., 0.01 cents per ad impression), action compensations 656 associated with different types of actions for the ad, retroactive bonus compensations 658 associated with different types of actions for the ad, and total compensations 660.

The action compensations 656 may include a first action compensation for a calling action (e.g., 0.4 cents for placing a phone call to a business number related to the ad), a second action compensation for a navigation action (e.g., 1 cents for navigating to a local store related to the ad), and a third action compensation for a purchase action (e.g., 4 cents for purchasing a product or service advertised in the ad).

The retroactive bonus compensations 658 may include a first retroactive bonus compensation for the calling action (e.g., 0.09 cents for placing a phone call to a business number related to the ad) if a first performance indicator associated with the calling action is satisfied, a second retroactive bonus compensation for the navigation action (e.g., 0.99 cents for navigating to a local store related to the ad) if a second performance indicator associated with the navigation action is satisfied, and a third retroactive bonus compensation for the purchase action (e.g., 0.99 cents for purchasing a product or service advertised in the ad) if a third performance indicator associated with the purchase action is satisfied.

The total compensations 660 may include a first total compensation (e.g., 0.01 cents) for presenting the ad to the user, a second total compensation (e.g., 0.5 cents) for the calling action if the first performance indicator associated with the calling action is satisfied, a third total compensation (e.g., 2 cents) for the navigation action if the second performance indicator associated with the navigation action is satisfied, and a fourth total compensation (e.g., 6 cents) for the purchase action if the third performance indicator associated with the purchase action is satisfied.

In some implementations, each time the ad “1234” is presented to the user, the ad delivery module 119 may notify the ad targeting module 117 of the presentation. If no action occurs, the ad targeting module 117 may determine that an advertiser associated with the ad may pay the ad targeting service provider an amount of the first total compensation (0.01 cents) per impression, which is equal to the ad impression compensation 654 (e.g., 0.01 cents).

If the user presses a control button after being presented with the ad, the ad delivery module 119 may determine an occurrence of an action and may notify the ad targeting module 117 of the action. If the action includes a calling action, the ad targeting module 117 may determine that the advertiser may at least pay the ad targeting service provider: (1) an amount of the ad impression compensation; and (2) an amount of the first action compensation (e.g., 0.4 cents) for the calling action. Furthermore, if the first performance indicator associated with the calling action is satisfied, the ad targeting module 117 may determine that the advertiser may also pay the ad targeting service provider an amount of the first retroactive bonus compensation (e.g., 0.09 cents) for the calling action. Thus, if the first performance indicator associated with the calling action is satisfied, the ad targeting module 117 may determine that the advertiser may pay the ad targeting service provider an amount of the second total compensation (e.g., 0.5 cents=0.01 cents+0.4 cents+0.09 cents) for the calling action.

Alternatively, if the action includes a navigation action, the ad targeting module 117 may determine that the advertiser may pay the ad targeting service provider: (1) an amount of the ad impression compensation; and (2) an amount of the second action compensation (e.g., 1 cent) for the navigation action. Furthermore, if the second performance indicator associated with the navigation action is satisfied, the ad targeting module 117 may determine that the advertiser may also pay the ad targeting service provider an amount of the second retroactive bonus compensation (e.g., 0.99 cents) for the navigation action. Thus, if the second performance indicator associated with the navigation action is satisfied, the ad targeting module 117 may determine that the advertiser may pay the ad targeting service provider an amount of the third total compensation (e.g., 2 cents=0.01 cents+1 cent+0.99 cents) for the navigation action.

Alternatively, if the action includes the navigation action and the purchase action, the ad targeting module 117 may determine that the advertiser may pay the ad targeting service provider: (1) an amount of the ad impression compensation; (2) an amount of the second action compensation for the navigation action; and (3) an amount of the third action compensation (e.g., 5 cents) for the purchase action. Furthermore, if the third performance indicator associated with the purchase action is satisfied, the ad targeting module 117 may determine that the advertiser may also pay the ad targeting service provider an amount of the third retroactive bonus compensation (e.g., 0.99 cents) for the purchase action. Thus, if the third performance indicator associated with the purchase action is satisfied, the ad targeting module 117 may determine that the advertiser may pay the ad targeting service provider an amount of the fourth total compensation (e.g., 6 cents=0.01 cents+1 cent+4 cents+0.99 cents) for the purchase action.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present implementations can be described above primarily with reference to user interfaces and particular hardware. However, the present implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present implementations of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some preferred implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method for determining an in-vehicle digital advertisement provided, via a network, to a vehicle for presentation to a user present in the vehicle and presented to the user via the hardware of the vehicle, the method comprising:
conducting, by a special purpose processor included in an electronic device and programmed to provide in-vehicle digital advertisements, an auction process to sell an advertisement time slot related to a digital advertisement to be presented in a vehicle, the auction process configured to identify an advertiser that offers a highest bidding price for the advertisement time slot;
selecting, by the special purpose processor, a digital advertisement from the advertiser associated with the highest bidding price, the digital advertisement targeted for a user present in the vehicle;
providing the digital advertisement to present in the vehicle;
receiving data, by a hardware communication unit, describing an in-vehicle presentation of the digital advertisement during the advertisement time slot;
determining, by the special purpose processor, an advertisement impression compensation paid by the advertiser responsive to the in-vehicle presentation of the digital advertisement;
receiving data, by the hardware communication unit, describing an occurrence of an action acted upon the digital advertisement;
verifying, by the special purpose processor, the occurrence of the action based on sensor data detected by a sensor of the vehicle, wherein the sensor data describes the occurrence of the action;
determining, by the special purpose processor, an action compensation paid by the advertiser based on a type of the action;
determining, by the special purpose processor, that a performance indicator associated with the type of the action is satisfied for a campaign of the digital advertisement;
determining, by the special purpose processor, a retroactive bonus compensation paid by the advertiser based on the type of the action responsive to the performance indicator being satisfied;
determining, by the special purpose processor, a total compensation that includes the advertisement impression compensation, the action compensation, and the retroactive bonus compensation;
receiving the total compensation from the advertiser; and
distributing the total compensation within a group of service providers.

2. A method for determining an in-vehicle digital advertisement provided, via a network, to a vehicle for presentation to a user present in the vehicle and presented to the user via the hardware of the vehicle, the method comprising:
determining, by a processor programmed to provide in-vehicle digital advertisements, a digital advertisement targeted for a user present in a vehicle;
providing the digital advertisement to be presented to the user in the vehicle;
receiving data describing an in-vehicle presentation of the digital advertisement;
determining an advertisement impression compensation paid by an advertiser responsive to the in-vehicle presentation of the digital advertisement;
receiving data describing a first action acted upon the digital advertisement;
determining a first action compensation paid by the advertiser based on a first type of the first action; and
determining a total compensation paid by the advertiser, the total compensation including the advertisement impression compensation and the first action compensation.

3. The method of claim 2, further comprising:
determining that a performance indicator associated with the first type of the first action is satisfied for a campaign of the digital advertisement; and
determining a retroactive bonus compensation paid by the advertiser based on the first type of the first action responsive to the performance indicator being satisfied,
wherein the total compensation further includes the retroactive bonus compensation.

4. The method of claim 3, wherein determining that the performance indicator associated with the first type of the first action is satisfied for the campaign of the digital advertisement includes determining that a percentage between a total number of users that have performed the first action and a total number of users that have been presented with the digital advertisement satisfies a condition specified in the performance indicator.

5. The method of claim 2, further comprising:
receiving the total compensation from the advertiser; and
distributing the total compensation in a group of providers that includes an advertisement targeting service provider and an advertisement delivery service provider.

6. The method of claim 2, further comprising conducting an auction process to sell an advertisement time slot for presenting the digital advertisement in the vehicle, wherein determining the advertisement targeted for the user further comprises selecting the digital advertisement associated with a highest bidding price from the auction process.

7. The method of claim 2, wherein the first action includes one of providing the user with navigation instructions to a location related to the digital advertisement, calling a phone number related to the digital advertisement, retrieving review information related to a product mentioned in the digital advertisement, automatically purchasing a product mentioned in the digital advertisement from an online store, automatically downloading a software program product described in the digital advertisement from an online store, making a purchase of the product mentioned in the digital advertisement from a local store, and digitally storing a digital coupon that is described in the digital advertisement.

8. The method of claim 2, further comprising:
receiving data describing a second action acted upon the digital advertisement; and
determining a second action compensation paid by the advertiser based on a second type of the second action,

9. The method of claim 2, wherein the total compensation further includes the second action compensation.

10. The method of claim 2, wherein the digital advertisement and the first action compensation are determined based in part on historical actions performed by at least one of the user and other users.

11. The method of claim 2, wherein the digital advertisement and the first action compensation are determined based in part on historical actions performed for at least one of the digital advertisement and other digital advertisements.

12. The method of claim 2, wherein the digital advertisement and the first action compensation are determined based in part on historical actions performed for a current category of digital advertisements that the digital advertisement belongs to.

13. The method of claim 2, wherein the digital advertisement and the first action compensation are determined based in part on user profile data associated with the user.

14. The method of claim 2, wherein the digital advertisement is supplemented with a piece of audio content conveying a call-to-action message, and the method further comprises:
determining, by the processor programmed to provide the in-vehicle digital advertisements, the audio content that conveys the call-to-action message associated with the digital advertisement based on permissible actions available for the digital advertisement; and
providing the audio content along with the digital advertisement to be presented to the user in the vehicle;
receiving data describing an in-vehicle presentation of the audio content that conveys the call-to-action message; and
determining the advertisement impression compensation paid by the advertiser responsive to the in-vehicle presentation of the audio content.

15. A non-transitory computer-readable medium having computer instructions stored thereon that are executable by a processor programmed to perform or control performance of operations, the operations comprising:
determining a digital advertisement targeted for a user present in a vehicle;
providing the advertisement, via a network, to be presented to the user in the vehicle;
receiving data describing an in-vehicle presentation of the digital advertisement;
determining an advertisement impression compensation paid by an advertiser responsive to the in-vehicle presentation of the digital advertisement;
receiving data describing a first action acted upon the digital advertisement;
determining a first action compensation paid by the advertiser based on a first type of the first action; and
determining a total compensation paid by the advertiser, the total compensation including the advertisement impression compensation and the first action compensation.

16. The non-transitory computer-readable medium of claim 15, wherein the operations further comprise:
determining that a performance indicator associated with the first type of the first action is satisfied for a campaign of the digital advertisement; and
determining a retroactive bonus compensation paid by the advertiser based on the first type of the first action responsive to the performance indicator being satisfied,
wherein the total compensation further includes the retroactive bonus compensation.

17. The non-transitory computer-readable medium of claim 15, wherein determining that the performance indicator associated with the first type of the first action is satisfied for the campaign of the digital advertisement includes determining that a percentage between a total number of users that have performed the first action and a total number of users that have been presented with the digital advertisement satisfies a condition specified in the performance indicator.

18. The non-transitory computer-readable medium of claim 15, wherein the operations further comprise:
receiving the total compensation from the advertiser; and
distributing the total compensation in a group of providers that includes an advertisement targeting service provider and an advertisement delivery service provider.

19. The non-transitory computer-readable medium of claim 15, wherein:
the operations further comprise conducting an auction process to sell an advertisement time slot for presenting the digital advertisement in the vehicle; and
determining the advertisement targeted for the user further comprises selecting the digital advertisement associated with a highest bidding price from the auction process.

20. The non-transitory computer-readable medium of claim 15, wherein the first action includes one of providing the user with navigation instructions to a location related to the digital advertisement, calling a phone number related to the digital advertisement, retrieving review information related to a product mentioned in the digital advertisement, automatically purchasing a product mentioned in the digital advertisement from an online store, making a purchase of the product mentioned in the digital advertisement from a local store, automatically downloading a software program product described in the digital advertisement from an online store, and digitally storing a digital coupon that is mentioned in the digital advertisement.

21. The non-transitory computer-readable medium of claim 15, wherein the operations further comprise:
receiving data describing a second action acted upon the digital advertisement; and
determining a second action compensation paid by the advertiser based on a second type of the second action,
wherein the total compensation further includes the second action compensation.

22. A method for presenting an in-vehicle digital advertisement to a user present in the vehicle and presented to the user via the hardware of the vehicle, the method comprising:
receiving, by an electronic device included in an onboard computer of a vehicle, a digital advertisement targeted for a user present in the vehicle;
presenting the digital advertisement to the user in the vehicle;
determining an occurrence of a button press event detected by a sensor of the vehicle, the button press event configured to trigger performance of an action;
determining an occurrence of the action based on the button press event; and
providing data describing the action.

23. The method of claim 22, wherein the button press event occurs on a control button of a steering wheel of the vehicle.

24. The method of claim 22, wherein the button press event occurs on a control button of an in-vehicle infotainment system of the vehicle.

25. The method of claim 22, further comprising receiving a verbal instruction from the user, wherein the occurrence of the action is further determined based on the verbal instruction.

26. The method of claim 22, wherein presenting the digital advertisement to the user further comprises:
incorporating the digital advertisement into a content stream being played in the vehicle, the digital advertisement configured to be played at an advertisement time slot; and
playing the digital advertisement in the vehicle during the advertisement time slot using one or more of a speaker system and a display device in the vehicle.

27. The method of claim 22, wherein the button press event occurs on a rewind hardware button associated with media control in the vehicle.
